(19) United States
(12) Patent Application Publication
(10) Pub. No.: US 2016/0155264 A1
(43) Pub. Date: Jun. 2, 2016

(54) ELECTRONIC DEVICE AND METHOD FOR REDUCING POINT CLOUD

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventors: ZHE-RUI WEI, Shenzhen (CN); LU YANG, Shenzhen (CN); XIN-YUAN WU, Shenzhen (CN); LING ZHANG, Shenzhen (CN)

(21) Appl. No.: 14/688,688

(22) Filed: Apr. 16, 2015

(30) Foreign Application Priority Data
Nov. 28, 2014 (CN) 201410710183.6

(51) Int. Cl. G06T 17/10

(52) U.S. Cl. CPC G06T 17/10; G06T 2210/56

(57) ABSTRACT

A method for reducing a point cloud includes receiving a mesh point cloud file uploaded to an electronic device and obtaining a number of data points of the point cloud from the mesh point cloud file, calculating a bounding box of the point cloud from the number of data points, dividing the bounding box into a number of cubes, determining effective cubes of the plurality of cubes, calculating a mean curvature of each of the effective cubes, determining a type of each of the effective cubes according to the mean curvature, reducing each effective cube according to the type of the effective cube to obtain a post-reduction cube, combining the post-reduction cubes to obtain a post-reduction point cloud, and restoring a mesh point cloud of the point cloud according to the post-reduction point cloud. An electronic device for reducing a point cloud is also provided.

### FIELD

The subject matter herein generally relates to point clouds, and more particularly to an electronic device and a method for reducing a point cloud.

### BACKGROUND

When scanning surfaces of an object, a plurality of scanned points of the surfaces can form a point cloud. The plurality of scanned points can be saved in the form of a mesh point cloud for further processing. Some of the scanned points may be deleted while still precisely representing the object to facilitate further processing of the mesh point cloud.

### BRIEF DESCRIPTION OF THE DRAWINGS

Implementations of the present technology will now be described, by way of example only, with reference to the attached figures.

FIG. 1 is a block diagram of an electronic device including a point cloud reduction system for reducing a point cloud.

FIG. 2 is a block diagram of function modules of the point cloud reduction system shown in FIG. 1.

FIG. 3 is a diagrammatic view illustrating a method for restoring a mesh point cloud from a post-reduction point cloud.

FIG. 4 is a flowchart of a method for reducing a point cloud.

FIG. 5 is a flowchart of a method for calculating an average curvature of an effective cube of a point cloud.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “comprising” means “including, but not necessarily limited to”; it specifically indicates open-ended inclusion or membership in a so-described combination, group, series and the like.

In general, the word “module” as used hereinafter refers to logic embodied in hardware or firmware, or to a collection of software instructions, written in a programming language such as, for example, Java, C, or assembly. One or more software instructions in the modules may be embedded in firmware such as in an erasable-programmable read-only memory (EPROM). It will be appreciated that the modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

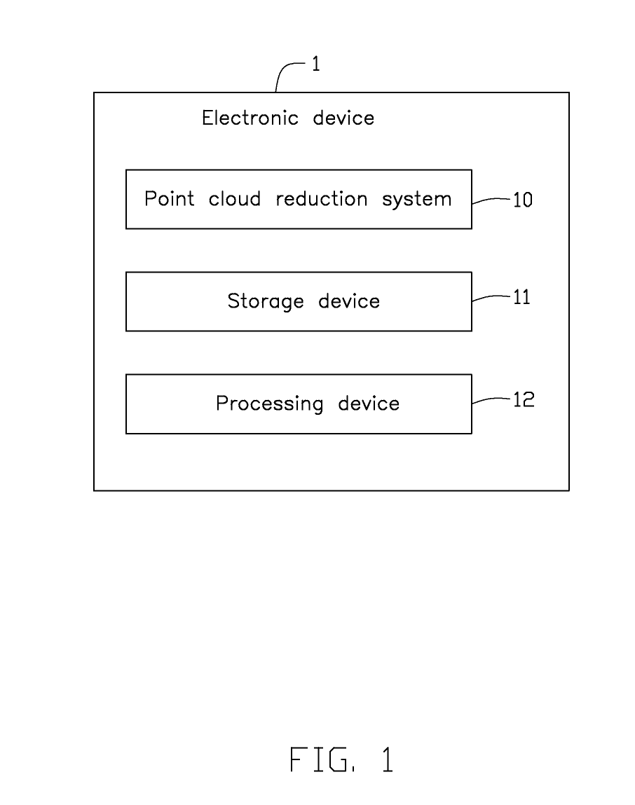

FIG. 1 illustrates an embodiment of an electronic device 1 for reducing a point cloud. The electronic device 1 can include a point cloud reduction system 10, a storage device 11, and a processing device 12. The electronic device 1 can be a personal computer, a server, or other suitable computing device. In at least one embodiment, the point cloud is reduced by calculating a bounding box of the point cloud, dividing the bounding box into a plurality of cubes, determining effective cubes of the plurality of cubes, calculating a mean curvature of each of the effective cubes, determining a type of each of the effective cubes according to the mean curvature, reducing each effective cube according to the type of the effective cube to obtain a post-reduction cube, combining the post-reduction cubes to obtain a post-reduction point cloud, and restoring a mesh point cloud according to the post-reduction point cloud.

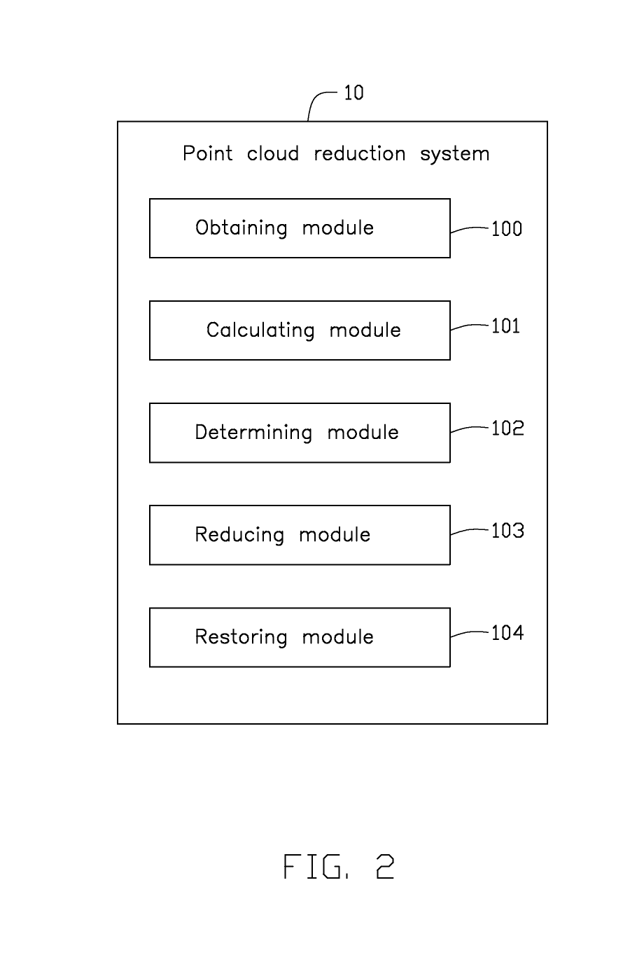

Referring to FIG. 2, the point cloud reduction system 10 can include a plurality of modules, such as an obtaining module 100, a calculating module 101, a determining module 102, a reducing module 103, and a restoring module 104. The modules 100-104 can include one or more software programs in the form of computerized codes stored in the storage device 11. The computerized codes can include instructions executed by the processing device 12 to provide functions for the modules 100-104.

The obtaining module 100 can obtain a mesh point cloud file uploaded by a user to the electronic device 1, and obtain a plurality of data points and information of the point cloud from the mesh point cloud file. In at least one embodiment, the data points of the point cloud form a plurality of triangles. Information of the point cloud can include three-dimensional coordinates of the vertices of each of the triangles, and three-dimensional coordinates of a unit normal vector of each of the triangles.

The calculating module 101 can calculate the bounding box of the point cloud. In detail, the calculating module 101 can determine maximum X, Y, and Z coordinate values of the point cloud, and determine minimum X, Y, and Z coordinate values of the point cloud. Boundaries of the bounding box along the X, Y, and Z axes are bound by the maximum and minimum X, Y, and Z coordinate values, respectively.

The calculating module can divide the bounding box into the plurality of cubes according to the following formula:

$$M = \frac{Δ X}{L} ;$$

$$N = \frac{Δ Y}{L} ;$$

$$W = \frac{Δ Z}{L} ;$$

wherein:
M, N, and W are numbers of the cubes along the X, Y, and Z axes, respectively;
Δ x is a difference between an average distance between adjacent points along the X axis and a smallest distance between the adjacent points along the X axis;
Δ y is a difference between an average distance between adjacent points along the Y axis and a smallest distance between the adjacent points along the Y axis;
Δ z is a difference between an average distance between adjacent points along the Z axis and a smallest distance between the adjacent points along the Z axis; and
L is a predetermined length.

The calculating module 101 can save a serial number of each of the cubes and of each of the data points of each cube to the storage device 11. The serial number of each cube can be linked to the serial number of each of the data points of the cube in a linked array. The calculating module 101 can determine which of the cubes are effective cubes. In at least one embodiment, each cube that has at least one data point is an effective cube. The calculating module 101 can save a serial number of each effective cube and of each of the data points of each effective cube to the storage device 11. The serial number of each effective cube can be linked to the serial number of each of the data points of the effective cube in a linked array.

The calculating module 101 can calculate the average curvature of each effective cube by determining a plurality of neighboring data points of each data point of the effective cube, calculating an average curvature of the effective cube at each data point according to the neighboring data points, and calculating an average of the average curvatures at all of the data points of the effective cube. The average curvature of the effective cube is equal to the average of the average curvatures at all of the data points of the effective cube.

The calculating module 101 can determine the plurality of neighboring data points of each data point of the effective cube by searching the serial number of the effective cube in the corresponding linked array to determine the data points of the effective cube, calculating a distance between the data point and each of six surfaces of the effective cube, determining which of the distances between the data point and each of the six surfaces is a minimum distance “dₘᵢₙ”, calculating a distance between the data point and each of the rest of the data points of the effective cube, and selecting a predetermined number “k” of the rest of the data points located farthest away from the data point. In at least one embodiment, the predetermined number “k” is eight. The calculating module 101 can determine whether a distance between the data point and each of the “k” data points is greater than the minimum distance “dₘᵢₙ”. If at least one of the “k” data points is located closer to the data point than the minimum distance “dₘᵢₙ”, the calculating module 101 selects data points from outside of the effective cube until the calculating module 101 obtains the predetermined number “k” of data points each located farther away from the data point than the minimum distance “dₘᵢₙ”.

The calculating module 101 can calculate the average curvature of the effective cube at each data point of the effective cube by calculating a plane of best fit at each point according to the neighboring data points, calculating a unit normal vector of the plane of best fit, calculating a tangent plane at the data point according to the unit normal vector, calculating a coordinate value of each of a plurality of projection points of the plurality of neighboring data points on the tangent plane, calculating a local parameterized coordinate of each of the neighboring data points according to the coordinate values of the plurality of projection points, calculating a parabola fitted to the plurality of neighboring data points according to the local parameterized coordinates, calculating coefficients of the parabola fitted to the plurality of neighboring data points, and calculating the average curvature at the data point according to the coefficients of the parabola.

In at least one embodiment, the plane of best fit is a least square plane. The calculating module 101 can calculate the plane of best fit according to the function: Ax=0; wherein:

### A=[P−Qᵢ];

x=(a, b, c)
P is the data point;
Qᵢ is a center point of the plurality of adjacent data points;
an eigenvalue and a plurality of eigenvectors “xᵢ(i=1, . . . , n) is calculated from a matrix (A^{T}A);
a smallest eigenvector xᵢ for the eigenvalue is the least square solution for the parameters (a, b, c) of the least square plane;
the least square solution for the parameters (a, b, c) of the least square plane is a starting value of the parameters (a, b, c);
the starting value of the parameters (a, b, c) of the least square plane is used to normalize a plurality of normal vectors N(a, b, c); and
the unit normal vector is equal to the normalized plurality of normal vectors N(a, b, c).

The calculating module 101 can calculate the tangent plane at the data point according to the equation:

Nᵢ×(Pⱼ−P)=Ax+By+Cz+D=0; wherein:

Nᵢ is the unit normal vector;
P is the data point; and
Pⱼ is a neighboring data point of the data point P.

The calculating module 101 can calculate a distance of the neighboring data point Pj from the tangent plane according to the equation: dⱼ=Axⱼ+Byⱼ+Czⱼ+D.

The calculating module 101 can calculate the coordinate value of the projection point of the neighboring data point Pj on the tangent plane according to the equation: Pⱼ^{P}=Pⱼ−dⱼNᵢ.

The calculating module 101 can calculate the local parameterized coordinate of each of the neighboring data points according to the Darboux frame. A neighboring point set is calculated by the following equation: (uⱼ,vⱼ,dⱼ)=((Pⱼ^{P}−Pᵢ^{P})×u, (Pⱼ^{P}−Pᵢ^{P})×(v,dⱼ)); wherein:

u=g/|g|, v=Nᵢ×u;
g=Pⱼ₊₁^{P}−Pⱼ^{P}; and
P is the origin point of the Darboux frame.

The calculating module 101 can calculate the parabola according to the equation: S(u,v)=(u,v,h(u,v))=(u,v,au²+buv+v²). The parabola is fitted to the neighboring points by calculating a smallest value of the equation:

$${\sum }_{i} {[ {h}_{i} - ( a {u}_{i}^{2} + b {u}_{i} {v}_{i} + c {v}_{i}^{2} ) ]}^{2} ;$$

wherein:
(a, b, c) are the coefficients of the parabolic equation, and (u, v, h) are the local parameterized coordinates of the fitted data points. A parabolic coefficient matrix X=[a,b,c]^{T}=(A^{T}A)⁻¹A^{T}B is a final solution of the parameters (a, b, c) of the least square plane; wherein:

$$A = [ \begin{matrix}{u}_{1}^{2} & {u}_{1} {v}_{1} & {v}_{1}^{2} \\ {u}_{2}^{2} & {u}_{2} {v}_{2} & {v}_{2}^{2} \\ ⋮ & ⋮ & ⋮ \\ {u}_{k + 1}^{2} & {u}_{k + 1} {v}_{k + 1} & {v}_{k + 1}^{2}\end{matrix} ] , X = [ \begin{matrix}a \\ b \\ c\end{matrix} ] , B = [ \begin{matrix}{h}_{1} \\ {h}_{2} \\ ⋮ \\ {h}_{k + 1}\end{matrix} ] ; and$$

$$A X = B .$$

The calculating module 101 can calculate the average curvature at the data point according to the equations:

$$K = {K}_{1} {K}_{2} = 4 a c - {b}^{2} , H = \frac{{K}_{1} + {K}_{2}}{2} = a + c ;$$

wherein:
H is the average curvature at the data point;
K is the Gaussian curvature at the data point;
K1 is a smallest curvature at the data point, and m1 is a direction of K1;
K2 is a largest curvature at the data point, and m2 is a direction of K2;

$${K}_{1} = a + c - \sqrt{{( a - c )}^{2} + {b}^{2}} ;$$

$${K}_{2} = a + c + \sqrt{{( a - c )}^{2} + {b}^{2}} ;$$

$${m}_{1} = \{ \begin{matrix}( a + c + \sqrt{{( a - c )}^{2} + {b}^{2}} , - b ) & a < c \\ ( b , c - a - \sqrt{{( a - c )}^{2} + {b}^{2}} ) & a \geq c\end{matrix} \} ; and$$

$${m}_{2} = \{ \begin{matrix}( b , c - a + \sqrt{{( a - c )}^{2} + {b}^{2}} ) & a < c \\ ( c - a - \sqrt{{( a - c )}^{2} + {b}^{2}} , b ) & a \geq c\end{matrix} \} .$$

The determining module 102 can determine the type of the effective cube according to the average curvature of the effective cube. In at least one embodiment, each effective cube can be a curved surface type or a flat surface type. The flat surface type has an average curvature less than a predetermined value. The curved surface type has an average curvature greater not less than the predetermined value.

The reducing module 103 can reduce each effective cube according to a reduction ratio uploaded to the electronic device 1. The reduction ratio represents a ratio of a number of data points of the post-reduction cube to a number of data points of the effective cube according to whether the effective cube is the curved surface type or the flat surface type. For example, in at least one embodiment, the curved surface type of the effective cubes has a ratio of 1:2, and the flat surface type of the effective cubes has a ratio of 1:8. Thus, for the curved surface type, for every two data points of the effective cube, one data point is used in the post-reduction cube, and for the flat surface type, for every eight data points of the effective cube, one data point is used in the post-reduction cube. After each of the effective cubes is reduced, the reducing module 103 combines the post-reduction cubes together to obtain the post-reduction point cloud.

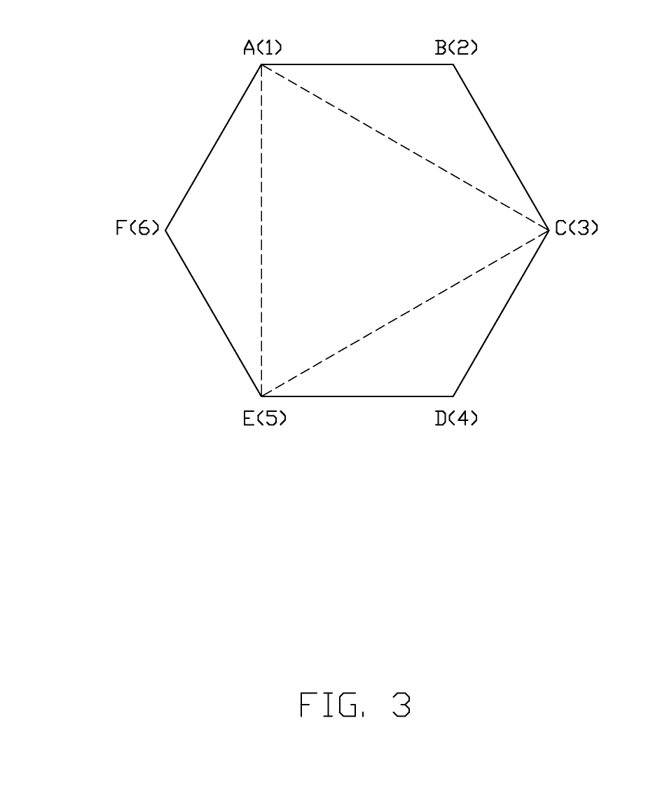

Referring to FIG. 3, the restoring module 104 can restore a mesh point cloud from the post-reduction point cloud. In detail, in a clockwise direction, for every three data points of the post-reduction point cloud, a first data point of the three data points is connected to a third data point of the three data points to form a triangle. Thus, a triangularly gridded structure of the point cloud is restored, and a total number of the data points of the point cloud is reduced.

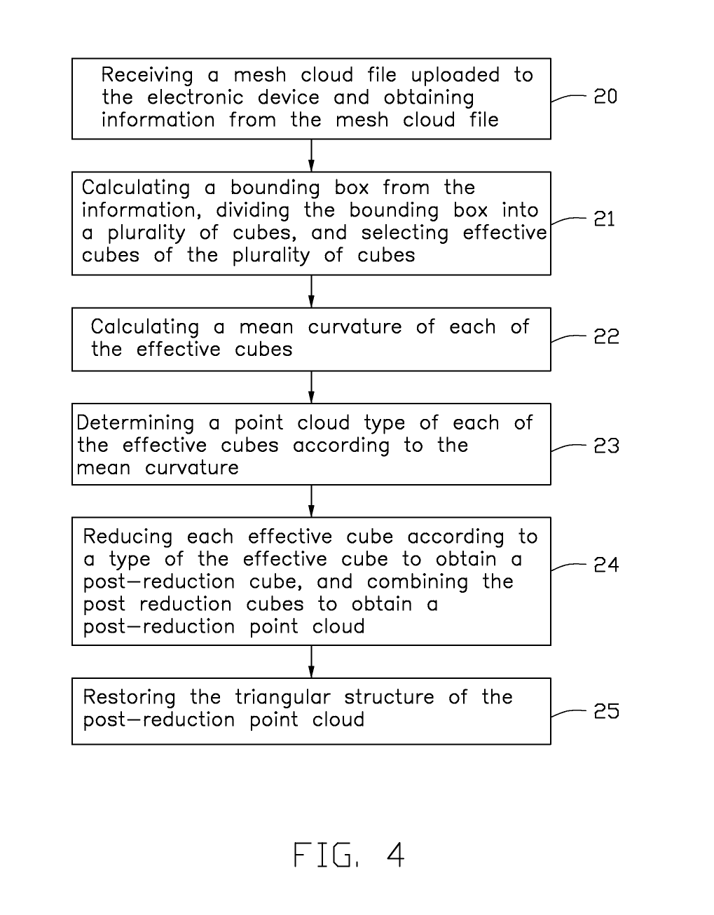

FIG. 4 illustrates a flowchart of an exemplary method of an electronic device reducing a point cloud. The example method is provided by way of example, as there are a variety of ways to carry out the method. The method described below can be carried out using the configurations illustrated in FIGS. 1-3, for example, and various elements of these figures are referenced in explaining the example method. Each block shown in FIG. 4 represents one or more processes, methods, or subroutines carried out in the example method. Furthermore, the illustrated order of blocks is by example only, and the order of the blocks can be changed. Additional blocks may be added or fewer blocks may be utilized, without departing from this disclosure. The example method can begin at block 20.

At block 20, the electronic device can obtain a mesh point cloud file uploaded by a user and obtain a plurality of data points and information of the point cloud from the mesh point cloud file. In at least one embodiment, the data points of the point cloud form a plurality of triangles. Information of the point cloud can include three-dimensional coordinates of the vertices of each of the triangles, and three-dimensional coordinates of a unit normal vector of each of the triangles.

At block 21, the electronic device can calculate a bounding box from the information, divide the bounding box into a plurality of cubes, and select effective cubes of the plurality of cubes.

To calculate the bounding box, the electronic device can determine maximum X, Y, and Z coordinate values of the point cloud, and determine minimum X, Y, and Z coordinate values of the point cloud. Boundaries of the bounding box along the X, Y, and Z axes are bound by the maximum and minimum X, Y, and Z coordinate values, respectively.

The electronic divide can divide the bounding box into the plurality of cubes according to the following formula:

$$M = \frac{Δ X}{L} ;$$

$$N = \frac{Δ Y}{L} ;$$

$$W = \frac{Δ Z}{L} ;$$

wherein:
M, N, and W are numbers of the cubes along the X, Y, and Z axes, respectively;
Δ x is a difference between an average distance between adjacent points along the X axis and a smallest distance between the adjacent points along the X axis;
Δ y is a difference between an average distance between adjacent points along the Y axis and a smallest distance between the adjacent points along the Y axis;
Δ z is a difference between an average distance between adjacent points along the Z axis and a smallest distance between the adjacent points along the Z axis; and
L is a predetermined length.

The electronic device can save a serial number of each of the cubes and of each of the data points of each cube. The serial number of each cube can be linked to the serial number of each of the data points of the cube in a linked array. The electronic device can determine which of the cubes are effective cubes. In at least one embodiment, each cube that has at least one data point is an effective cube. The electronic device can save a serial number of each effective cube and of each of the data points of each effective cube to the storage device 11. The serial number of each effective cube can be linked to the serial number of each of the data points of the effective cube in a linked array.

At block 22, the electronic device can calculate an average curvature of each effective cube by determining a plurality of neighboring data points of each data point of the effective cube, calculating an average curvature of the effective cube at each data point according to the neighboring data points, and calculating an average of the average curvatures at all of the data points of the effective cube. The average curvature of the effective cube is equal to the average of the average curvatures at all of the data points of the effective cube.

At block 23, the electronic device can determine the type of the effective cube according to the average curvature of the effective cube. In at least one embodiment, each effective cube can be a curved surface type or a flat surface type. The flat surface type has an average curvature less than a predetermined value. The curved surface type has an average curvature greater not less than the predetermined value.

At block 24, the electronic device can reduce each effective cube according to a reduction ratio uploaded to the electronic device 1. The reduction ratio represents a ratio of a number of data points of the post-reduction cube to a number of data points of the effective cube according to whether the effective cube is the curved surface type or the flat surface type. For example, in at least one embodiment, the curved surface type of the effective cubes has a ratio of 1:2, and the flat surface type of the effective cubes has a ratio of 1:8. Thus, for the curved surface type, for every two data points of the effective cube, one data point is used in the post-reduction cube, and for the flat surface type, for every eight data points of the effective cube, one data point is used in the post-reduction cube. After each of the effective cubes is reduced, the electronic device combines the post-reduction cubes together to obtain the post-reduction point cloud.

At block 25, the electronic device can restore a mesh point cloud from the post-reduction point cloud. In detail, in a clockwise direction, for every three data points of the post-reduction point cloud, a first data point of the three data points is connected to a third data point of the three data points to form a triangle. Thus, a triangularly gridded structure of the point cloud is restored, and a total number of the data points of the point cloud is reduced.

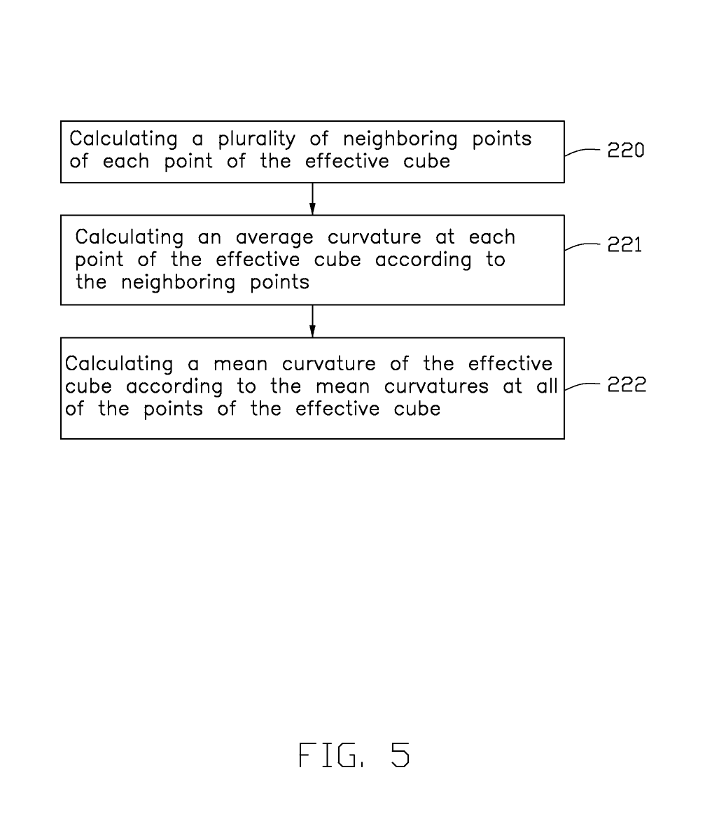

FIG. 5 illustrates a flowchart of an exemplary method of an electronic device calculating a mean curvature of an effective cube of a point cloud. The example method is provided by way of example, as there are a variety of ways to carry out the method. The method described below can be carried out using the configurations illustrated in FIGS. 1-3, for example, and various elements of these figures are referenced in explaining the example method. Each block shown in FIG. 5 represents one or more processes, methods, or subroutines carried out in the example method. Furthermore, the illustrated order of blocks is by example only, and the order of the blocks can be changed. Additional blocks may be added or fewer blocks may be utilized, without departing from this disclosure. The example method can begin at block 220.

At block 220, the electronic device can calculate a plurality of neighboring points of each point of the effective cube. The electronic device can calculate the plurality of neighboring data points of each data point of the effective cube by searching the serial number of the effective cube in the corresponding linked array to determine the data points of the effective cube, calculating a distance between the data point and each of six surfaces of the effective cube, determining which of the distances between the data point and each of the six surfaces is a minimum distance “dₘᵢₙ”, calculating a distance between the data point and each of the rest of the data points of the effective cube, and selecting a predetermined number “k” of the rest of the data points located farthest away from the data point. In at least one embodiment, the predetermined number “k” is eight. The electronic device can determine whether a distance between the data point and each of the “k” data points is greater than the minimum distance “dₘᵢₙ”. If at least one of the “k” data points is located closer to the data point than the minimum distance “dₘᵢₙ”, the electronic device selects data points from outside of the effective cube until the electronic device obtains the predetermined number “k” of data points each located farther away from the data point than the minimum distance “dₘᵢₙ”.

At block 221, the electronic device can calculate an average curvature of the effective cube at each data point of the effective cube by calculating a plane of best fit at each point according to the neighboring data points, calculating a unit normal vector of the plane of best fit, calculating a tangent plane at the data point according to the unit normal vector, calculating a coordinate value of each of a plurality of projection points of the plurality of neighboring data points on the tangent plane, calculating a local parameterized coordinate of each of the neighboring data points according to the coordinate values of the plurality of projection points, calculating a parabola fitted to the plurality of neighboring data points according to the local parameterized coordinates, calculating coefficients of the parabola fitted to the plurality of neighboring data points, and calculating the average curvature at the data point according to the coefficients of the parabola.

In at least one embodiment, the plane of best fit is a least square plane. The electronic device can calculate the plane of best fit according to the function: Ax=0; wherein:

### A=[P−Qᵢ];

x=(a, b, c)
P is the data point;
Qᵢ is a center point of the plurality of adjacent data points;
an eigenvalue and a plurality of eigenvectors “xᵢ(i=1, . . . , n) is calculated from a matrix (A^{T}A);
a smallest eigenvector xᵢ for the eigenvalue is the least square solution for the parameters (a, b, c) of the least square plane;
the least square solution for the parameters (a, b, c) of the least square plane is a starting value of the parameters (a, b, c);
the starting value of the parameters (a, b, c) of the least square plane is used to normalize a plurality of normal vectors N(a, b, c); and
the unit normal vector is equal to the normalized plurality of normal vectors N(a, b, c).

The electronic device can calculate the tangent plane at the data point according to the equation:

Nᵢ×(Pⱼ−P)=Ax+By+Cz+D=0; wherein:

Nᵢ is the unit normal vector;
P is the data point; and
Pⱼ is a neighboring data point of the data point P.

The electronic device can calculate a distance of the neighboring data point Pj from the tangent plane according to the equation: dⱼ=Axⱼ+Byⱼ+Czⱼ+D.

The electronic device can calculate the coordinate value of the projection point of the neighboring data point Pj on the tangent plane according to the equation: Pⱼ^{P}−Pⱼ−dⱼNᵢ.

The electronic device can calculate the local parameterized coordinate of each of the neighboring data points according to the Darboux frame. A neighboring point set is calculated by the following equation: (uⱼ,vⱼ,dⱼ)=((Pⱼ^{P}−Pᵢ^{P})×u, (Pⱼ^{P}−Pᵢ^{P})×(v,dⱼ)); wherein:

u=g/|g|, v=Nᵢ×u;
g=Pⱼ₊₁^{P}−Pⱼ^{P}; and
P is the origin point of the Darboux frame.

The electronic device can calculate the parabola according to the equation: S(u,v)=(u,v,h(u,v))=(u,v,au²+buv+v²). The parabola is fitted to the neighboring points by calculating a smallest value of the equation:

$${\sum }_{i} {[ {h}_{i} - ( a {u}_{i}^{2} + b {u}_{i} {v}_{i} + c {v}_{i}^{2} ) ]}^{2} ;$$

wherein:
(a, b, c) are the coefficients of the parabolic equation, and (u, v, h) are the local parameterized coordinates of the fitted data points. A parabolic coefficient matrix X=[a,b,c]^{T}=(A^{T}A)⁻¹A^{T}B is a final solution of the parameters (a, b, c) of the least square plane; wherein:

$$A = [ \begin{matrix}{u}_{1}^{2} & {u}_{1} {v}_{1} & {v}_{1}^{2} \\ {u}_{2}^{2} & {u}_{2} {v}_{2} & {v}_{2}^{2} \\ ⋮ & ⋮ & ⋮ \\ {u}_{k + 1}^{2} & {u}_{k + 1} {v}_{k + 1} & {v}_{k + 1}^{2}\end{matrix} ] , X = [ \begin{matrix}a \\ b \\ c\end{matrix} ] , B = [ \begin{matrix}{h}_{1} \\ {h}_{2} \\ ⋮ \\ {h}_{k + 1}\end{matrix} ] ; and$$

$$A X = B .$$

The electronic device can calculate the average curvature at the data point according to the equations:

$$K = {K}_{1} {K}_{2} = 4 a c - {b}^{2} , H = \frac{{K}_{1} + {K}_{2}}{2} = a + c ;$$

wherein:
H is the average curvature at the data point;
K is the Gaussian curvature at the data point;
K1 is a smallest curvature at the data point, and m1 is a direction of K1;
K2 is a largest curvature at the data point, and m2 is a direction of K2;

$${K}_{1} = a + c - \sqrt{{( a - c )}^{2} + {b}^{2}} ;$$

$${K}_{2} = a + c + \sqrt{{( a - c )}^{2} + {b}^{2}} ;$$

$${m}_{1} = \{ \begin{matrix}( a + c + \sqrt{{( a - c )}^{2} + {b}^{2}} , - b ) & a < c \\ ( b , c - a - \sqrt{{( a - c )}^{2} + {b}^{2}} ) & a \geq c\end{matrix} \} ; and$$

$${m}_{2} = \{ \begin{matrix}( b , c - a + \sqrt{{( a - c )}^{2} + {b}^{2}} ) & a < c \\ ( c - a - \sqrt{{( a - c )}^{2} + {b}^{2}} , b ) & a \geq c\end{matrix} \} .$$

At block 222, the electronic device can calculate the mean curvature of the effective cube by calculating an average of the mean curvatures at all of the data points of the effective cube. The mean curvature of the effective cube is equal to the average of the mean curvatures at all of the data points of the effective cube.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A method for reducing a point cloud, the method comprising:
receiving a mesh cloud file uploaded to an electronic device;
obtaining a plurality of data points of the point cloud from the mesh cloud file;
calculating a bounding box of the point cloud from the plurality of data points;
dividing the bounding box into a plurality of cubes, and determining effective cubes of the plurality of cubes;
calculating a mean curvature of each of the effective cubes;
determining a type of each of the effective cubes according to the mean curvature;
reducing each effective cube according to the type of each of the effective cubes to obtain a plurality of post-reduction cubes, and combining the plurality of post-reduction cubes to obtain a post-reduction point cloud; and
restoring a mesh point cloud according to the post-reduction point cloud.

2. The method as in claim 1, wherein:
the data points of the point cloud form a plurality of triangles; and
information of the point cloud comprises three-dimensional coordinates of the vertices of each of the triangles, and three-dimensional coordinates of a unit normal vector of each of the triangles.

3. The method as in claim 2, wherein the bounding box is calculated by:
determining maximum X, Y, and Z coordinate values of the point cloud; and
determining minimum X, Y, and Z coordinate values of the point cloud;
wherein boundaries of the bounding box along the X, Y, and Z axes are bound by the maximum and minimum X, Y, and Z coordinate values, respectively.

4. The method as in claim 3, wherein the bounding box is divided into a plurality of cubes according to the following formula:
$$M = \frac{Δ X}{L} ;$$
$$N = \frac{Δ Y}{L} ;$$
$$W = \frac{Δ Z}{L} ;$$
wherein:
M, N, and W are numbers of the cubes along the X, Y, and Z axes, respectively;
Δ x is a difference between an average distance between adjacent points along the X axis and a smallest distance between the adjacent points along the X axis;
Δ y is a difference between an average distance between adjacent points along the Y axis and a smallest distance between the adjacent points along the Y axis;
Δ z is a difference between an average distance between adjacent points along the Z axis and a smallest distance between the adjacent points along the Z axis; and
L is a predetermined length.

5. The method as in claim 4, wherein a serial number of each of the cubes and of each of the data points of each cube are saved and linked to each other in a linked array;

6. The method as in claim 5, wherein the effective cubes are the cubes that have at least one data point.

7. The method as in claim 6, wherein a serial number of each of the effective cubes and of each of the data points of each effective cube are saved and linked together in a linked array.

8. The method as in claim 7, wherein the average curvature of each effective cube is calculated by:
determining a plurality of neighboring data points of each data point of the effective cube;
calculating an average curvature of the effective cube at each data point according to the neighboring data points; and
calculating an average of the average curvatures at all of the data points of the effective cube;
wherein the average curvature of the effective cube is equal to the average of the average curvatures at all of the data points of the effective cube.

9. The method as in claim 8, wherein a method of determining the plurality of neighboring data points of each data point of the effective cube comprises:
searching the serial number of the effective cube in the corresponding linked array to determine the data points of the effective cube;
calculating a distance between the data point and each of six surfaces of the effective cube, and determining which of the distances between the data point and each of the six surfaces of the effective cube is a minimum distance “dₘᵢₙ”;
calculating a distance between the data point and each of the rest of the data points of the effective cube;
selecting a predetermined number “k” of the rest of the data points located farthest away from the data point;
determining whether each of the predetermined number “k” of data points is located farther away from the data point than the minimum distance “dₘᵢₙ”; and
selecting data points from outside of the effective cube until obtaining the predetermined number “k” of data points each located farther away from the data point than the minimum distance “dₘᵢₙ”.

10. The method as in claim 8, wherein a process of calculating the average curvature of the effective cube at each data point of the effective cube comprises:
calculating a plane of best fit at each point according to the neighboring data points;
calculating a unit normal vector of the plane of best fit;
calculating, according to the unit normal vector, a tangent plane at the data point, and calculating a coordinate value of each of a plurality of projection points of the plurality of neighboring data points on the tangent plane;
calculating, according to the coordinate values of the plurality of projection points, a local parameterized coordinate of each of the neighboring data points;
calculating, according to the local parameterized coordinates, a parabola fitted to the plurality of neighboring data points;
calculating coefficients of the parabola fitted to the plurality of neighboring data points; and
calculating, according to the coefficients of the parabola, the average curvature at the data point;
wherein the plane of best fit is a least square plane;
a function of calculating the least square plane is: Ax=0;
A=[P−Qᵢ];
x=(a, b, c)
P is the data point;
Qᵢ is a center point of the plurality of adjacent data points;
an eigenvalue and a plurality of eigenvectors “xᵢ(i=1, . . . , n) is calculated from a matrix (A^{T}A);
a smallest eigenvector xᵢ for the eigenvalue is the least square solution for the parameters (a, b, c) of the least square plane;
the least square solution for the parameters (a, b, c) of the least square plane is a starting value of the parameters (a, b, c);
the starting value of the parameters (a, b, c) of the least square plane is used to normalize a plurality of normal vectors N(a, b, c);
the unit normal vector is equal to the normalized plurality of normal vectors N(a, b, c);
the tangent plane at the data point is calculated by the equation: Nᵢ×(Pⱼ−P)=Ax+By+Cz+D=0;
Nᵢ is the unit normal vector;
P is the data point;
Pⱼ is a neighboring data point of the data point P;
a distance of the neighboring data point Pⱼ from the tangent plane is calculated by the equation: dⱼ=Axⱼ+Byⱼ+Czⱼ+D;
the coordinate value of the projection point of the neighboring data point Pⱼ on the tangent plane is calculated by the equation: Pⱼ^{P}=Pⱼ−dⱼNᵢ;
the local parameterized coordinate of each of the neighboring data points is calculated by using the Darboux frame;
a neighboring point set is calculated by the following equation: (uⱼ,vⱼ,dⱼ)=((Pⱼ^{P}−Pᵢ^{P})×u, (Pⱼ^{P}−Pᵢ^{P})×(v,dⱼ));
u=g/|g|, v=Nᵢ×u;
g=Pⱼ₊₁^{P}+Pⱼ^{P};
P is the origin point of the Darboux frame;
the parabola is calculated by the following equation: S(u,v)=(u,v,h(u,v))=(u,v,au²+buv+v²);
the parabola is fitted to the neighboring points by calculating a smallest value of the following equation:
$${\sum }_{i} {[ {h}_{i} - ( a {u}_{i}^{2} + b {u}_{i} {v}_{i} + c {v}_{i}^{2} ) ]}^{2} ;$$
(a, b, c) are the coefficients of the parabolic equation, and (u, v, h) are the local parameterized coordinates of the fitted data points;
a parabolic coefficient matrix X=[a,b,c]^{T}=(A^{T}A)⁻¹A^{T}B is a final solution of the parameters (a, b, c) of the least square plane;
$$A = [ \begin{matrix}{u}_{1}^{2} & {u}_{1} {v}_{1} & {v}_{1}^{2} \\ {u}_{2}^{2} & {u}_{2} {v}_{2} & {v}_{2}^{2} \\ ⋮ & ⋮ & ⋮ \\ {u}_{k + 1}^{2} & {u}_{k + 1} {v}_{k + 1} & {v}_{k + 1}^{2}\end{matrix} ] , X = [ \begin{matrix}a \\ b \\ c\end{matrix} ] , B = [ \begin{matrix}{h}_{1} \\ {h}_{2} \\ ⋮ \\ {h}_{k + 1}\end{matrix} ] ;$$
$$A X = B ;$$
the average curvature at the data point is calculated by the following equations:
$$K = {K}_{1} {K}_{2} = 4 a c - {b}^{2} , H = \frac{{K}_{1} + {K}_{2}}{2} = a + c ;$$
H is the average curvature at the data point;
K is the Gaussian curvature at the data point;
K₁ is a smallest curvature at the data point, and m₁ is a direction of K₁;
K₂ is a largest curvature at the data point, and m₂ is a direction of K₂;
$${K}_{1} = a + c - \sqrt{{( a - c )}^{2} + {b}^{2}} ;$$
$${K}_{2} = a + c + \sqrt{{( a - c )}^{2} + {b}^{2}} ;$$
$${m}_{1} = \{ \begin{matrix}( a + c + \sqrt{{( a - c )}^{2} + {b}^{2}} , - b ) & a < c \\ ( b , c - a - \sqrt{{( a - c )}^{2} + {b}^{2}} ) & a \geq c\end{matrix} \} ; and$$
$${m}_{2} = \{ \begin{matrix}( b , c - a + \sqrt{{( a - c )}^{2} + {b}^{2}} ) & a < c \\ ( c - a - \sqrt{{( a - c )}^{2} + {b}^{2}} , b ) & a \geq c\end{matrix} \} .$$

11. The method as in claim 8, wherein:
the type of each effective cube is either a curved surface type or a flat surface type;
the flat surface type of the effective cubes has an average curvature less than a predetermined value;
the curved surface type of the effective cubes has an average curvature not less than the predetermined value; and
each effective cube is reduced according to the curved surface type or the flat surface type.

12. The method as in claim 11, wherein:
a reduction ratio is uploaded to the electronic device by a user, the reduction ratio representing a ratio of a number of data points of the post-reduction cube to a number of data points of the effective cube according to the type of the effective cube;
each effective cube is divided into a plurality of reducing cubes;
a serial number of each of the reducing cubes and of each of the data points of each reducing cube are saved and linked to each other in a linked array;
each reducing cube is reduced according to the reduction ratio and the type of the effective cube to obtain a post-reduction cube; and
the post reduction cubes are combined to obtain the post-reduction point cloud.

13. The method as in claim 12, wherein:
in a clockwise direction, for every three data points of the post-reduction point cloud, a first data point of the three data points is connected to a third data point of the three data points to form a triangle to restore the mesh point cloud of the point cloud.

14. An electronic device for reducing a point cloud, the electronic device comprising:
a point cloud reduction system configured to reduce the point cloud;
a storage device configured to store a plurality of instructions of a plurality of modules of the point cloud system; and
a processing device configured to implement the plurality of instructions of the plurality of modules of the point cloud system, the plurality of modules comprising:
an obtaining module configured to obtain a mesh point cloud file uploaded by a user, and obtain a plurality of data points and information of the point cloud from the mesh point cloud file;
a calculating module configured to calculate a bounding box of the point cloud from the plurality of data points, divide the bounding box into a plurality of cubes, determine effective cubes of the plurality of cubes; and calculate a mean curvature of each of the effective cubes;
a determining module configured to determine a type of each of the effective cubes according to the mean curvature;
a reducing module configured to reduce a quantity of the plurality of data points of each effective cube according to the type of the effective cube to obtain a plurality of post-reduction cubes, and combine the post reduction cubes to obtain a post-reduction point cloud; and
a restoring module configured to restore a mesh point cloud from the post-reduction point cloud;
wherein the data points of the point cloud form a plurality of triangles; and
wherein the information of the point cloud comprises three-dimensional coordinates of the vertices of each of the triangles and three-dimensional coordinates of a unit normal vector of each of the triangles.

15. The electronic device as in claim 14, wherein the calculating module calculates the bounding box by:
determining maximum X, Y, and Z coordinate values of the point cloud; and
determining minimum X, Y, and Z coordinate values of the point cloud;
wherein boundaries of the bounding box along the X, Y, and Z axes are bound by the maximum and minimum X, Y, and Z coordinate values, respectively.

16. The electronic device as in claim 15, wherein the calculating module divides the bounding box into a plurality of cubes according to the following formula:
$$M = \frac{Δ X}{L} , \\ N = \frac{Δ Y}{L} , \\ W = \frac{Δ Z}{L}$$
wherein:
M, N, and W are numbers of the cubes along the X, Y, and Z axes, respectively;
Δ x is a difference between an average distance between adjacent points along the X axis and a smallest distance between the adjacent points along the X axis;
Δ y is a difference between an average distance between adjacent points along the Y axis and a smallest distance between the adjacent points along the Y axis;
Δ z is a difference between an average distance between adjacent points along the Z axis and a smallest distance between the adjacent points along the Z axis; and
L is a predetermined length;
the calculating module saves and links a serial number of each of the cubes and of each of the data points of each cube to each other in a linked array;
the effective cubes are the cubes that have at least one data point;
the calculating module saves and links a serial number of each of the effective cubes and of each of the data points of each effective cube together in a linked array.

17. The electronic device as in claim 16, wherein the calculating module calculates the average curvature of each effective cube by:
determining a plurality of neighboring data points of each data point of the effective cube;
calculating an average curvature of each data point of the effective cube according to the neighboring data points; and
calculating an average of the average curvatures of all of the data points of the effective cube;
wherein the average curvature of the effective cube is equal to the average of the average curvatures of all of the data points of the effective cube.

18. The electronic device as in claim 17, wherein a method of the calculating module determining the plurality of neighboring data points of each data point of the effective cube comprises:
searching the serial number of the data point in the corresponding linked array to determine the effective cube;
calculating a distance between the data point and each of six surfaces of the effective cube, and determining which of the distances between the data point and each of the six surfaces of the effective cube is a minimum distance “dₘᵢₙ”;
calculating a distance between the data point and each of the rest of the data points of the effective cube;
selecting a predetermined number “k” of the rest of the data points located farthest away from the data point;
determining whether each of the predetermined number “k” of data points is located farther away from the data point than the minimum distance “dₘᵢₙ”; and
selecting data points from outside of the effective cube until obtaining the predetermined number “k” of data points each located farther away from the data point than the minimum distance “dₘᵢₙ”.

19. The electronic device as in claim 17, wherein a process of the calculating module calculating the average curvature of each data point of the effective cube comprises:
calculating a plane of best fit of each point according to the neighboring data points;
calculating a unit normal vector of the plane of best fit;
calculating, according to the unit normal vector, a tangent plane of the data point, and calculating a coordinate value of each of a plurality of projection points of the plurality of neighboring data points on the tangent plane;
calculating, according to the coordinate values of the plurality of projection points, a local parameterized coordinate of each of the neighboring data points;
calculating, according to the local parameterized coordinates, a parabola fitted to the plurality of neighboring data points;
calculating coefficients of the parabola fitted to the plurality of neighboring data points; and
calculating, according to the coefficients of the parabola, the average curvature of the data point;
wherein the plane of best fit is a least square plane;
a function of calculating the least square plane is: Ax=0;
A=[P−Qᵢ];
x=(a, b, c)
P is the data point;
Qᵢ is a center point of the plurality of adjacent data points;
an eigenvalue and a plurality of eigenvectors “xᵢ(i=1, . . . , n) is calculated from a matrix (A^{T}A);
a smallest eigenvector xᵢ for the eigenvalue is the least square solution for the parameters (a, b, c) of the least square plane;
the least square solution for the parameters (a, b, c) of the least square plane is a starting value of the parameters (a, b, c);
the starting value of the parameters (a, b, c) of the least square plane is used to normalize a plurality of normal vectors N(a, b, c);
the unit normal vector is equal to the normalized plurality of normal vectors N(a, b, c);
the tangent plane of the data point is calculated by the equation: Nᵢ×(Pⱼ−P)=Ax+By+Cz+D=0;
Nᵢ is the unit normal vector;
P is the data point;
Pⱼ is a neighboring data point of the data point P;
a distance of the neighboring data point Pⱼ from the tangent plane is calculated by the equation: dⱼ=Axⱼ+Byⱼ+Czⱼ+D;
the coordinate value of the projection point of the neighboring point Pⱼ on the tangent plane is calculated by the equation: Pⱼ^{P}=Pⱼ−dⱼNᵢ;
the local parameterized coordinate of each of the neighboring data points is calculated by using the Darboux frame;
a neighboring point set is calculated by the following equation: (uⱼ,vⱼ,dⱼ)=((Pⱼ^{P}−Pᵢ^{P})×u, (Pⱼ^{P}−Pᵢ^{P})×(v,dⱼ));
u=g/|g|, v=Nᵢ×u;
g=Pⱼ₊₁^{P}−Pⱼ^{P};
P is the origin point of the Darboux frame;
the parabola is calculated by the following equation: S(u,v)=(u,v,h(u,v))=(u,v,au²+buv+v²);
the parabola is fitted to the neighboring points by calculating a smallest value of the following equation:
$${\sum }_{i} {[ {h}_{i} - ( a {u}_{i}^{2} + b {u}_{i} {v}_{i} + c {v}_{i}^{2} ) ]}^{2} ;$$
(a, b, c) are the coefficients of the parabolic equation, and (u, v, h) are the local parameterized coordinates of the fitted data points;
a parabolic coefficient matrix X=[a,b,c]^{T}=(A^{T}A)⁻¹A^{T}B is a final solution of the parameters (a, b, c) of the least square plane;
$$A = [ \begin{matrix}{u}_{1}^{2} & {u}_{1} {v}_{1} & {v}_{1}^{2} \\ {u}_{2}^{2} & {u}_{2} {v}_{2} & {v}_{2}^{2} \\ ⋮ & ⋮ & ⋮ \\ {u}_{k + 1}^{2} & {u}_{k + 1} {v}_{k + 1} & {v}_{k + 1}^{2}\end{matrix} ] , X = [ \begin{matrix}a \\ b \\ c\end{matrix} ] , B = [ \begin{matrix}{h}_{1} \\ {h}_{2} \\ ⋮ \\ {h}_{k + 1}\end{matrix} ] ;$$
$$A X = B ;$$
the average curvature of the data point is calculated by the following equations:
$$K = {K}_{1} {K}_{2} = 4 a c - {b}^{2} , H = \frac{{K}_{1} + {K}_{2}}{2} = a + c ;$$
H is the average curvature of the data point;
K is the Gaussian curvature of the data point;
K₁ is a smallest curvature of the data point, and m₁ is a direction of K₁;
K₂ is a largest curvature of the data point, and m₂ is a direction of K₂;
$${K}_{1} = a + c - \sqrt{{( a - c )}^{2} + {b}^{2}} ;$$
$${K}_{2} = a + c + \sqrt{{( a - c )}^{2} + {b}^{2}} ;$$
$${m}_{1} = \{ \begin{matrix}( a + c + \sqrt{{( a - c )}^{2} + {b}^{2}} , - b ) & a < c \\ ( b , c - a - \sqrt{{( a - c )}^{2} + {b}^{2}} ) & a \geq c\end{matrix} \} ;$$
$${m}_{2} = \{ \begin{matrix}( b , c - a + \sqrt{{( a - c )}^{2} + {b}^{2}} ) & a < c \\ ( c - a - \sqrt{{( a - c )}^{2} + {b}^{2}} , b ) & a \geq c\end{matrix} \} .$$

20. The electronic device as in claim 17, wherein:
the type of each effective cube is either a curved surface type or a flat surface type;
the flat surface type of the effective cubes has an average curvature less than a predetermined value;
the curved surface type of the effective cubes has an average curvature not less than the predetermined value;
each effective cube is reduced according to the curved surface type or the flat surface type;
a reduction ratio is uploaded to the electronic device by a user, the reduction ratio representing a ratio of a number of data points of the post-reduction cube to a number of data points of the effective cube according to the type of the effective cube;
each effective cube is divided into a plurality of reducing cubes;
a serial number of each of the reducing cubes and of each of the data points of each reducing cube are saved and linked to each other in a linked array;
each reducing cube is reduced according to the reduction ratio and the type of the effective cube to obtain a post-reduction cube;
the post reduction cubes are combined to obtain the post-reduction point cloud; and
in a clockwise direction, for every three data points of the post-reduction point cloud, a first data point of the three data points is connected to a third data point of the three data points to form a triangle to restore the mesh point cloud of the point cloud.
